(19) United States
(12) Patent Application Publication
(10) Pub. No.: US 2003/0159558 A1
(43) Pub. Date: Aug. 28, 2003

(54) CUT AND REMOVAL APPARATUS AND METHOD

(76) Inventor: Hiroshi Takayama, Osaka (JP)

Correspondence Address: Thomas g Eschweiller, Eschweidler & Associates, National City Bank Building, 629 Euclid Avenue, Suite 1210, Cleveland, OH, 44114, US

(21) Appl. No.: 10/275,131

(22) PCT Filed: Mar. 2, 2001
(86) PCT No.: PCT/JP01/01652

(51) Int. Cl. B26D 1/56; B26D 7/06; B23D 25/12

(52) U.S. Cl. 83/100; 83/23; 83/343; 83/113

(57) ABSTRACT

According to the present invention, through holes (30) are formed in a web (3) in cooperation between an anvil roll (1) and a loop-shaped blade (20) of a cutter roll (2). A die-cut portion (31) is adsorbed to an inner-loop region (21) of the cutter roll (2), and then discharged by being sucked into a duct (80) while air is jet out from air vents (22) in the inner-loop region (21).

### TECHNICAL FIELD

The present invention relates to a cut and removal apparatus and a cut and removal method for forming a through hole in a predetermined shape in a single-layer or multilayer sheet-like member.

### BACKGROUND ART

As one of methods for forming through holes in a sheet-like member, known is a method using a cutter roll called a die cutter (see Japanese Laid-Open Patent Publication No. 8-71999 and No. 11-188698, for example). The cutter roll die-cuts a sheet-like member in cooperation with an anvil roll. In this prior art, however, no disclosure is made on how to dispose of die-cut portions die-cut off from the sheet-like member. If die-cut portions are not properly disposed of, a die of the cutter roll and the like may be clogged with such die-cut portions, and as a result, frequent cleaning of the cutter roll may be necessary. This reduces the serviceability ratio of the apparatus.

Japanese Laid-Open Patent Publication No. 8-52696 discloses an apparatus for producing sanitary goods by die-cutting a whole cloth sheet. In this prior art, die-cut sanitary goods are passed to a feed roll to be transported to a next process stage.

The feed roll that receives the sanitary goods by adsorption rotates while keeping external contact with the cutter roll. Therefore, the structure of the prior art is not suitable for high-speed operation. Moreover, since the cutter roll performs only sucking, suction holes thereof are easily clogged. This reduces the serviceability ratio of the apparatus.

In order to overcome the above problems, an object of the present invention is to provide a cut and removal apparatus and a cut and removal method capable of attaining a high serviceability ratio and high-speed operation.

### DISCLOSURE OF THE INVENTION

To attain the object of the present invention, according to one embodiment of the invention, the cut and removal apparatus includes an anvil roll, a cutter roll, and a suction part.

The cutter roll is placed in an almost-contact position with respect to the anvil roll. The cutter roll has at least one blade in a loop shape for die-cutting off a predetermined portion from a sheet-like member. The cutter roll has an air vent for supplying and discharging air in an inner-loop region surrounded by the blade, and holds a die-cut portion obtained by the die-cutting with the blade. The suction part is placed at a position apart from the outer circumference of the cutter roll for sucking the held die-cut portion.

As used herein, the “almost-contact position” refers to the position in which the anvil roll and the cutter roll are in parallel with each other and are close to or in contact with each other to such a degree that the blade of the cutter roll can die-cut the sheet-like member in cooperation with the anvil roll.

According to one embodiment of the present invention, the cut and removal method uses the cut and removal apparatus described above. In this method, the cutter roll rotates while the sheet-like member is being fed between the two rolls. The method includes steps of decompression, die-cutting, transportation, pressurization, and charging performed during one rotation of the cutter roll.

In the decompression step, a plurality of air vents in the inner-loop region communicate with a negative pressure chamber to reduce the atmospheric pressure near the surface of the inner-loop region. In the die-cutting step, the blade is in contact with the surface of the anvil roll so that the die-cut portion is die-cut off from the sheet-like member with the blade. In the transportation step, the die-cut portion is transported along the circumference of the cutter roll while being kept adsorbed to the surface of the inner-loop region. In the pressurization step, the plurality of air vents in the inner-loop region communicate with a positive pressure chamber to raise the atmospheric pressure near the surface of the inner-loop region. In the charging step, the die-cut portion in the inner-loop region is sucked into the suction part and discharged.

According to the present invention, air is supplied to the air vents to which the die-cut portion is adsorbed. This prevents the air vents from clogging, and therefore improves the serviceability ratio of the apparatus.

The die-cut portion held on the cutter roll is sucked into and transported through the suction part located apart from the surface of the cutter roll. This enables high-speed operation of the apparatus.

In the present invention, the die-cut portion sucked into the suction part may be collected and discarded, or may be recycled.

In the present invention, the shape of the through holes formed by die-cutting the sheet-like member may be circular, oval, or polygonal, or may be any combination of straight lines and/or curved lines.

The blade of the cutter roll is looped, which generally exhibits higher strength than a non-looped blade.

The thickness of the blade of the cutter roll is preferably determined so that the area of the portion of the blade coming into contact with the anvil roll is substantially constant at any time. This makes it possible to keep constant the pressure exerted when the blade of the cutter roll is brought into contact with the anvil roll.

The cutter roll and the anvil roll may be made of a material such as tool steel, high-speed tool steel, powder high-speed tool steel by HIP and sintering, and cemented carbide. The hardness may be different between the cutter roll and the anvil roll. For a longer life of the blade, the hardness of the cutter roll is preferably greater than the hardness of the anvil roll.

The blade may be coated with diamond-like carbon.

When two or more blades are provided, the blades may preferably be placed at an equiangular pitch for nicely balanced rotation of the cutter roll.

In the discharging step, as the distance between the suction inlet of the suction part and the blade is smaller, the suction part can suck the die-cut portion stably. However, if the distance is too small, the die-cut portion is easily caught on the blade or easily twisted about near the suction inlet, possibly damaging the suction part and the blade. Therefore, in general, the distance is preferably set at 5 mm to 45 mm.

One or more air vents are provided for one inner-loop region. In general, a plurality of, or a number of air vents having small open ends are preferably provided.

In a preferred example of the present invention, the cut and removal apparatus described above further includes a negative pressure chamber turned to a negative pressure and a positive pressure chamber turned to a positive pressure. The plurality of air vents are placed to communicate with one of the negative pressure chamber and the positive pressure chamber alternately via at least one path depending on the phase of the inner-loop region. The area of an open end of the path communicating with the negative pressure chamber or the positive pressure chamber is preferably equal to or greater than the sum of the cross-sectional areas of the plurality of air vents.

By setting the area as described above, the negative pressure from the negative pressure chamber and the positive pressure from the positive pressure chamber act effectively near the surface of the inner-loop region.

As used herein, the “phase” refers to the angle measured from the reference point.

In the present invention, the size of the die-cut portion is not limited. However, in a preferred example of the present invention, the area of the die-cut portion, that is, the area of the inner-loop region is set in a range of about 10 cm² to about 70 cm². If the area of the die-cut portion exceeds 70 cm², the opening of the suction part must be made large. This increases suction loss.

In another preferred example of the present invention, the suction part has a roughly circular opening for sucking the die-cut portion, and the diameter of the opening is set at roughly one to five times as large as the length of the blade in the rotation direction of the cutter roll.

If the opening of the suction part is excessively large compared with the blade, the suction part may fail to suck the die-cut portion, or suction loss increases.

In yet another preferred example of the present invention, the surface of the inner-loop region of the cutter roll protrudes outwards in the radial direction of the cutter roll from the surface of the portion of the cutter roll outside the blade. In the inner-loop region, air between the die-cut portion and the surface of the cutter roll is sucked. Therefore, with the above structure in this preferred example, it is possible to swiftly reduce the atmospheric pressure in the inner-loop region, and also possible to easily feed the sheet-like member between the cutter roll and the anvil roll.

According to another embodiment of the present invention, the cut and removal apparatus includes an anvil roll, a cutter roll, a suction device, an air supply device, and a duct.

The cutter roll is placed in an almost-contact position with respect to the anvil roll. The cutter roll has a blade in a loop shape for die-cutting off a predetermined portion. The cutter roll has an air vent in an inner-loop region surrounded by the blade. The suction device sucks air through the air vent while the inner-loop region rotates over a first range of predetermined phases to adsorb a die-cut portion obtained by the die-cutting with the blade to the surface of the inner-loop region. The air supply device supplies air between the surface of the inner-loop region and the die-cut portion through the air vent during rotation of the inner-loop region over a second range of other predetermined phases. The duct sucks the die-cut portion from outside the cutter roll to transport the die-cut portion together with air during rotation of the inner-loop region over the second range.

In a preferred example of the present invention, the suction device includes a first chamber communicating with the air vent during the rotation over the first phase range. The air supply device includes a second chamber communicating with the air vent during the rotation over the second phase range. The two chambers are formed in (defined by) a neighboring member located near the cutter roll, and separated from each other to prevent communication with each other.

According to another embodiment of the present invention, the cut and removal method uses the cut and removal apparatus of the embodiment described above. This method includes steps of decompression, die-cutting, transportation, pressurization, and charging performed during one rotation of the cutter roll.

In the decompression step, a plurality of air vents in the inner-loop region communicate with the first chamber to reduce the atmospheric pressure near the surface of the inner-loop region. In the die-cutting step, the blade is in contact with the surface of the anvil roll so that the die-cut portion is die-cut off from the sheet-like member with the blade. In the transportation step, the die-cut portion is transported along the circumference of the cutter roll while being kept adsorbed to the surface of the inner-loop region. In the pressurization step, the plurality of air vents in the inner-loop region communicate with the second chamber to raise the atmospheric pressure near the surface of the inner-loop region. In the charging step, the die-cut portion in the inner-loop region is sucked into the duct together with air and discharged.

As used herein, the “sheet-like member” refers to a cloth-like structure having a large area compared with its thickness, including fiber laminates and the like in addition to films and cloths. It may be continuous in the form of a roll such as a web, and as a concept, it includes semimanufactures of sanitary napkins and disposable diapers and pants.

### BRIEF DESCRIPTION OF THE DRAWINGS

The present invention will be more clearly understood by reading the following description of preferred examples in conjunction with the accompanying drawings. It should be understood, however, that the examples disclosed herein in conjunction with the drawings are presented merely for illustration and description of the invention and should not be used for restricting the present invention. The present invention is only restricted by the appended claims. In the accompanying drawings, the same or like components are denoted by the same reference numerals throughout the drawings.

FIG. 1 is an exploded perspective view showing an outline of a cut and removal apparatus of the first example of the present invention.

FIG. 2 is a side layout of the cut and removal apparatus.

FIG. 3 is a partially omitted vertical section of a cutter roll.

FIG. 4 is a layout of a cut and removal apparatus of the second example.

FIG. 5 is a plan view of an anvil roll.

### BEST MODE FOR CARRYING OUT THE INVENTION

Hereinafter, examples of the present invention will be described with reference to the relevant drawings.

### FIRST EXAMPLE

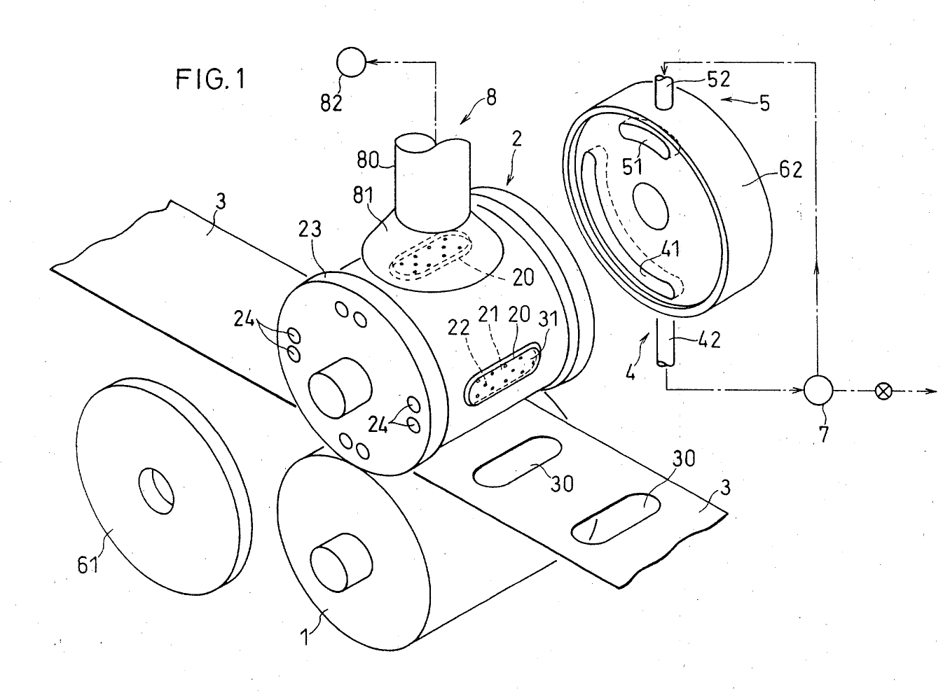

FIGS. 1 to 3 illustrate the first example.

Referring to FIG. 1, a continuous sheet-like member, that is, a web 3 is fed between an anvil roll 1 and a cutter roll 2. By the passing of the web 3 between the cutter roll 2 and the anvil roll 1, predetermined portions (die-cut portions) 31 are die-cut off from the web 3, forming through holes 30 in the web 3 at a predetermined pitch.

The cutter roll 2 is in an almost-contact position with respect to the anvil roll 1. The cutter roll 2 has a plurality of blades 20, for example. The blades 20, each in a loop shape, are used for die-cutting off the die-cut portions 31. In this example, increased-diameter flange portions 23 of the cutter roll 2 are in external contact with the anvil roll 1. The flange portions 23 serve to stabilize the rotation of the cutter roll 2 and protect the blades 20.

First and second fixing members (neighboring members) 61 and 62 are provided on the two sides of the cuter roll 2, and the fixing members 61 and 62 are secured to a frame not shown.

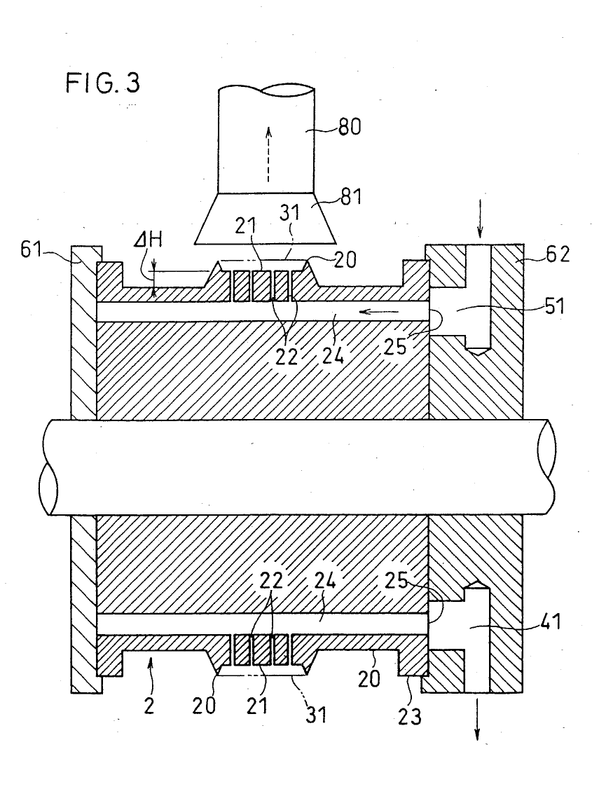

A number of air vents 22 are formed in an inner-loop region 21 of each blade 20 of the cutter roll 2. As clearly shown in FIG. 3, the air vents 22 extend in the radial direction of the cutter roll 2 and open externally at the inner-loop region 21, so that the die-cut portion 31 is adsorbed to and held on the surface of the inner-loop region 21, as will be described later.

Referring to FIG. 1, the illustrated cut and removal apparatus includes a suction device 4 and an air supply device 5.

Inside the cutter roll 2, a plurality of communicating paths 24 communicating with the air vents 22 extend in parallel with each other in the axial direction. As shown in FIG. 3, one end of each of the communicating paths 24 is closed by the first fixing plate 61, while the other end thereof communicates with a negative pressure chamber (first chamber) 41 or a positive pressure chamber (second chamber) 51 formed inside the second fixing plate 62.

The negative pressure chamber 41 and the positive pressure chamber 51 are separated from each other to prevent communication with each other, while they communicate with a pneumatic source 7 via piping members 42 and 52, and the like. The pneumatic source 7, which includes a pump, a tank, an ejector, and the like although they are not shown, sucks air inside the negative pressure chamber 41 via the piping member 42 and supplies pressure air into the positive pressure chamber 51 via the piping member 52.

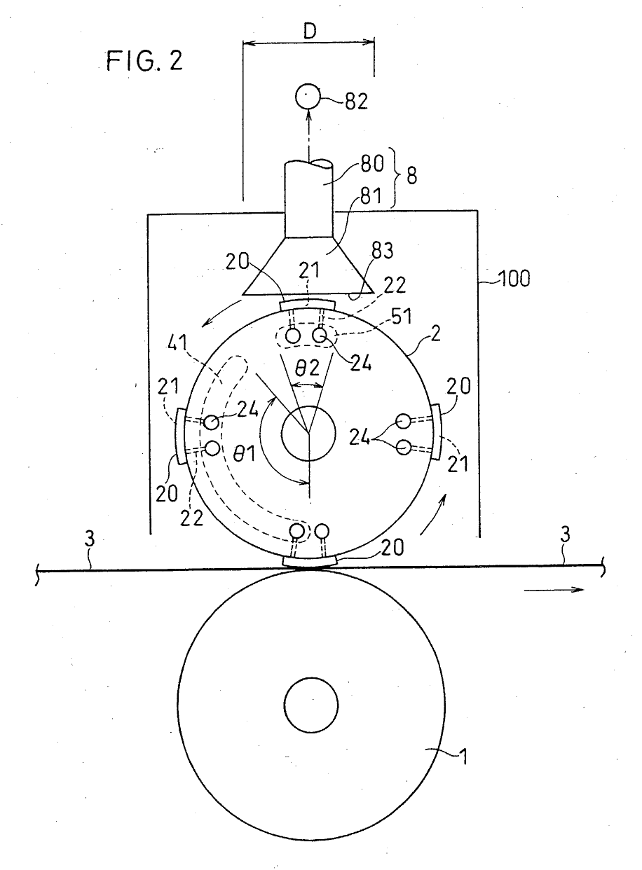

Referring to FIG. 2, while the inner-loop region 21 rotates over a first range θ1 of predetermined phases, the air vents 22 in this inner-loop region communicate with the negative pressure chamber 41 via the communication path 24. The suction device 4 shown in FIG. 1 sucks air through the air vents 22 to allow the die-cut portion 31 cut off with the blade 20 to be adsorbed to the surface of the inner-loop region 21.

Referring to FIG. 3, while the inner-loop region 21 rotates over a second range θ2 of other predetermined phases (FIG. 2), the air vents 22 communicate with the positive pressure chamber 51 via the communicating path 24. The air supply device 5 supplies air under pressure out to a space between the surface of the inner-loop region 21 and the die-cut portion 31 through the air vents 22.

Referring to FIG. 2, a tapered hood 81 coupled to a duct 80 is placed in the vicinity of the cutter roll 2. The duct 80 communicates with a pneumatic source 82 for sucking air inside the duct 80. The pneumatic source 7 may also serve as the pneumatic source 82. The duct 80 and the hood 81 constitute a suction part 8. During the rotation of the inner-loop region 21 over the second range θ2, the suction part 8 sucks the die-cut portion 31 from outside the cutter roll 2 into the duct 80 and transports it together with air.

Next, the cut and removal method will be described.

The cutter roll 2 rotates while the sheet-like member 3 is being fed between the two rolls 1 and 2. During one rotation of the cutter roll 2, process steps of decompression, die-cutting, transportation, pressurization, and discharging are performed.

Once the inner-loop region 21 reaches the first range θ1 by the rotation of the cutter roll 2, the decompression step starts, in which the plurality of air vents 22 in the inner-loop region 21 come to communicate with the negative pressure chamber 41 via the communicating path 24, to allow the pneumatic source 7 to suck air through the air vents 22. As a result, the atmospheric pressure near the surface of the inner-loop region 21 gradually decreases.

As the inner-loop region 21 comes closer to the surface of the anvil roll 1, the die-cutting step starts, in which the blade 20 comes into contact with the surface of the anvil roll 1, to allow the die-cut portion 31 (FIG. 1) to be die-cut off from the sheet-like member 3 in cooperation between the blade 20 and the anvil roll 1. The die-cut portion 31 is then adsorbed to the surface of the inner-loop region 21.

In the transportation step, the die-cut portion 31, that is kept adsorbed to the surface of the inner-loop region 21, is transported along the circumference of the cutter roll 2 with the rotation of the anvil roll 1.

When the inner-loop region 21 reaches the second range θ2 as the cutter roll 2 continues rotating, the pressurizing step starts, in which the plurality of air vents 22 in the inner-loop region 21 communicate with the positive pressure chamber 51 via the communicating path 24, to allow the pneumatic source 7 to supply compressed air to the air vents 22 under pressure. As a result, the atmospheric pressure near the surface of the inner-loop region 21 increases.

In the discharging step, with the increased atmospheric pressure, the die-cut portion 31 adsorbed to the surface of the inner-loop region 21 becomes easily detached from the surface of the cutter roll 2. The die-cut portion 31 is therefore sucked at a suction inlet 83 of the hood 81 into the duct 80 together with air and discharged.

With continuous rotation of the cutter roll 2, the above process steps are performed in sequence for the respective inner-loop regions 21, forming the through holes 30 in the web 3 at a predetermined pitch by die-cutting. Note that the anvil roll 1 is rotatable.

In the cut and removal method described above, as shown in FIG. 3, when the die-cut portion 31 is sucked into the duct 80, compressed air is jet from the air vents 22-. This makes the air vents 22 resistant to clogging and also prevents the die-cut portion 31 from blocking the inner-loop region 21. In addition, the die-cut portion 31 is sucked into the hood 81 of which the opening is located apart from the cutter roll 2. This enables high-speed operation of the apparatus.

In this apparatus, it is preferable to set the area of the open end 25 of each of the communicating paths 24 communicating with the negative pressure chamber 41 or the positive pressure chamber 51 and the cross-sectional area of the communicating path 24 to be equal to or more than the sum of the cross-sectional areas of the plurality of air vents 22 communicating with the communicating path 24. Only one communicating path 24, or a plurality of communicating paths 24 may communicate with one inner-loop region 21. Note however that the first and second ranges θ1 and θ2 shown in FIG. 2 should be set so that one inner-loop region 21 is prevented from communicating both the negative pressure chamber 41 and the positive pressure chamber 51 simultaneously.

The area of the die-cut portion 31, that is, the area of the inner-loop region 21 is preferably set at 10 cm² to 70 cm².

In this apparatus, the surface of the inner-loop region 21 preferably protrudes outwards in the radial direction of the cutter roll 2 by a slight amount ΔH from the surface of the portion of the cutter roll 2 outside the blade 20. This can reduce the capacity of air existing between the die-cut portion 31 and the surface of the cutter roll 2 in the inner-loop region 21, and thus shorten the time required for decompression.

Referring to FIG. 2, the diameter D of the suction inlet 83 of the hood 81 is preferably equal to or larger than the length of the blade 20 in the rotation direction of the cutter roll 2 and equal to or smaller than five times as large as the length of the blade 20.

A cover and door 100 covering the cutter roll 2 and the like may be provided for prevention of entering of dirt and dust.

### SECOND EXAMPLE

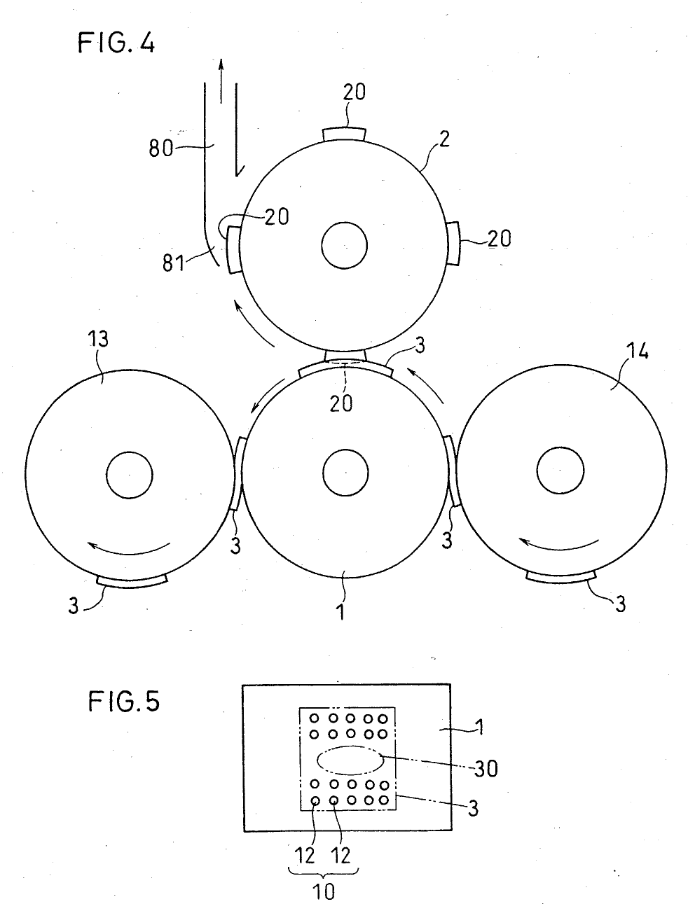

FIGS. 4 and 5 illustrate the second example.

As shown in FIG. 4, in the apparatus of this example, through holes 30 may be formed for discontinuous sheet-like members. In this case, as shown in FIG. 5, the anvil roll 1 includes a holding section 10 for holding the sheet-like member 3. The holding section 10 may be constructed of an arm or the like for pressing the sheet-like member 3 against the surface of the anvil roll 1. In general, however, the holding section 10 is preferably composed of a plurality of air vents 12 to provide adsorption function with air as in the cutter roll 2 described above.

In this case, it is necessary to establish a predetermined positional relationship between the holding section 10 and the blade 20 and a predetermined phase relationship between the anvil roll 1 and the cutter roll 2. As the means for feeding and transporting the web 3, transfer drums 13 and 14 may be used.

The other construction in this example is substantially the same as that in the first example, and therefore the same or corresponding components are denoted by the same reference numerals, and the detailed description thereof is omitted here.

Thus, preferred embodiments were described with reference to the relevant drawings. It is believed obvious to those skilled in the art that changes and modifications of the present invention are possible in light of the above teaching and known techniques.

For example, the plurality of blades are not necessarily placed at an equiangular pitch only one blade 20 may be provided on the cutter roll 2. The flange portions 23 may not be provided. The pneumatic sources 7 and 82 may be united.

Such changes and modifications are therefore construed to fall within the scope of the present invention as defined by the appended claims.

### INDUSTRIAL APPLICABILITY

The present invention is applicable to high-speed machine for continuously forming through holes in a sheet-like member.

1. A cut and removal apparatus for forming a through hole in a predetermined portion of a sheet-like member, comprising:
an anvil roll;
a cutter roll placed in an almost-contact position with respect to said anvil roll, said cutter roll having at least one blade in a loop shape for die-cutting the predetermined portion off from the sheet-like member, said cutter roll having an air vent for supplying and discharging air in an inner-loop region surrounded by said blade, and holding a die-cut portion obtained by the die-cutting with said blade; and
a suction part placed at a position apart from the outer circumference of said cutter roll for sucking the held die-cut portion.

2. The cut and removal apparatus according to claim 1, further comprising a negative pressure chamber turned to a negative pressure and a positive pressure chamber turned to a positive pressure,
wherein said air vent comprises a plurality of air vents, said air vents being able to communicate with one of said negative pressure chamber and said positive pressure chamber alternately via at least one path depending on the phase of said inner-loop region, and
the area of an open end of said path communicating with said negative pressure chamber or said positive pressure chamber is equal to or greater than the sum of the cross-sectional areas of the plurality of air vents in said inner-loop region.

3. The cut and removal apparatus according to claim 1, wherein the area of said inner-loop region is set in a range of about 10 cm² to about 70 cm².

4. The cut and removal apparatus according to claim 1, wherein said suction part has a roughly circular suction inlet for sucking said die-cut portion, and the diameter of said suction inlet is set at roughly one to five times as large as the length of said blade in the rotation direction of said cutter roll.

5. The cut and removal apparatus according to claim 1, wherein the surface of said inner-loop region protrudes outwards in the radial direction of said cutter roll from the surface of the portion of said cutter roll outside said blade.

6. A cut and removal method using the cut and removal apparatus according to claim 1, wherein said cutter roll rotates while said sheet-like member is being fed between said two rolls, and steps of decompression, die-cutting, transportation, pressurization, and charging are performed during one rotation of said cutter roll,
wherein in said decompression step, the air vent in said inner-loop region communicates with a negative pressure chamber to reduce the atmospheric pressure near the surface of said inner-loop region,
in said die-cutting step, said blade is in contact with the surface of said anvil roll so that said die-cut portion is die-cut off from said sheet-like member with said blade,
in said transportation step, said die-cut portion is transported along the circumference of said cutter roll while being kept adsorbed to the surface of said inner-loop region,
in said pressurization step, the air vent in said inner-loop region communicates with a positive pressure chamber to raise the atmospheric pressure near the surface of said inner-loop region, and
in said charging step, said die-cut portion in said inner-loop region is sucked into said suction part and discharged.

7. A cut and removal apparatus for die-cutting off and removing a predetermined portion from a sheet-like member, comprising:
an anvil roll;
a cutter roll placed in an almost-contact position with respect to said anvil roll, said cutter roll having a blade in a loop shape for die-cutting off said predetermined portion, said cutter roll having an air vent in an inner-loop region surrounded by said blade; and
a suction device for sucking air through said air vent while said inner-loop region rotates over a first range of pre-determined phases to adsorb a die-cut portion obtained by the die-cutting with said blade to the surface of said inner-loop region;
an air supply device for supplying air between the surface of said inner-loop region and said die-cut portion through said air vent during rotation of said inner-loop region over a second range of other predetermined phases; and
a duct for sucking said die-cut portion from outside said cutter roll to transport said die-cut portion together with air during rotation of said inner-loop region over said second range, said duct including a suction inlet apart from the outer circumference of said cutter roll.

8. The cut and removal apparatus according to claim 7, wherein said suction device includes a first chamber communicating with said air vent during the rotation of said inner-loop region over said first range,
said air supply device includes a second chamber communicating with said air vent during the rotation of said inner-loop region over said second range, and
said two chambers are formed in a neighboring member located near said cutter roll, and separated from each other to prevent communication with each other.

9. A cut and removal method using the cut and removal apparatus according to claim 8, wherein said cutter roll rotates while said sheet-like member is being fed between said two rolls, and steps of decompression, die-cutting, transportation, pressurization, and charging are performed during one rotation of said cutter roll,
wherein in said decompression step, the air vent in said inner-loop region communicates with a negative pressure chamber to reduce the atmospheric pressure near the surface of said inner-loop region,
in said die-cutting step, said blade is in contact with the surface of said anvil roll so that said die-cut portion is die-cut off from said sheet-like member with said blade,
in said transportation step, said die-cut portion is transported along the circumference of said cutter roll while being kept adsorbed to the surface of said inner-loop region,
in said pressurization step, the air vent in said inner-loop region communicates with said second chamber to raise the atmospheric pressure near the surface of said inner-loop region, and
in said charging step, said die-cut portion in said inner-loop region is sucked into said duct together with air and discharged.
